(19) United States
(12) Patent Application Publication
(10) Pub. No.: US 2016/0161628 A1
(43) Pub. Date: Jun. 9, 2016

(54) DEEP SENSING SYSTEMS

(71) Applicant: HALLIBURTON ENERGY SERVICES, INC., Houston, TX (US)

(72) Inventors: MICHAEL BITTAR, HOUSTON, TX (US); JING LI, HOUSTON, TX (US)

(21) Appl. No.: 14/907,781

(22) PCT Filed: Sep. 3, 2013
(86) PCT No.: PCT/US2013/057817

§ 371 Date: Jan. 26, 2016

(51) Int. Cl. G01V 3/30

(52) U.S. Cl. CPC G01V 3/30

(57) ABSTRACT

Transmitting and receiving electromagnetic signals into and from a subterranean formation may include use of an antenna capable of transmitting and of receiving relatively low frequency electromagnetic signals, thereby enabling sensing at great depths. Utilization of a mostly buried dielectric slab with an exposed end may minimize the antenna's profile, facilitating integration into drilling equipment such as a drilling collar, mandrel, or wireline tool.

### BACKGROUND

The present disclosure relates generally to subterranean drilling operations and, more particularly, the present disclosure relates to formation sensing systems, apparatus, and methods.

Hydrocarbons, such as oil and gas, are commonly obtained from subterranean formations that may be located onshore or offshore. The development of subterranean operations and the processes involved in removing hydrocarbons from a subterranean formation are complex. Typically, subterranean operations involve a number of different steps such as, for example, drilling a wellbore at a desired well site, treating the wellbore to optimize production of hydrocarbons, and performing the necessary steps to produce and process the hydrocarbons from the subterranean formation.

When performing subterranean operations, it is often desirable to obtain information about the formation.

The basic techniques for electromagnetic logging for earth formations are well known. For instance, induction logging to determine resistivity (or its inverse, conductivity) of earth formations adjacent a borehole has long been a standard and important technique in the search for and recovery of hydrocarbons. Generally, a transmitter transmits an electromagnetic signal that passes through formation materials and induces a signal in one or more receivers. The properties of the signal received, such as its amplitude and/or phase, are influenced by the formation resistivity, enabling resistivity measurements to be made. The measured signal characteristics and/or formation properties calculated therefrom may be recorded as a function of the tool's depth or position in the borehole, yielding a formation log that can be used to analyze the formation.

At greater depths, a lower frequency (i.e., longer wavelength) electromagnetic signal may be required for accurate measurements. However, conventional transmitters frequently require a large profile; for example, cavity antennas may be about a half wavelength tall, often limiting their frequency of transmission to about 1 GHz or higher. Antennas with smaller profiles, such as patch antennas, are often not suitable for use in a drilling environment due to features such as, e.g., multiple propagation paths for electromagnetic signals, and insufficient mechanical strength and water resistance for deployment in a downhole environment.

### FIGURES

Some specific exemplary embodiments of the disclosure may be understood by referring, in part, to the following description and the accompanying drawings.

FIGS. 1A-B are diagrams showing aspects of a logging tool according to some embodiments of the present disclosure.

FIGS. 2A-B are cross-sectional diagrams showing a logging tool incorporating aspects of the present disclosure.

FIG. 3 is a diagram showing an illustrative logging while drilling environment.

FIG. 4 is a diagram showing an illustrative wireline logging environment.

FIG. 5 is a diagram showing aspects of a logging tool including antennas according to some embodiments of the present disclosure.

FIGS. 6A-B are diagrams showing aspects of another logging tool including antennas according to some embodiments of the present disclosure.

FIG. 7 is a diagram showing aspects of a logging tool including antenna arrays according to some embodiments of the present disclosure.

FIGS. 8A-B is a diagram showing aspects of a logging tool including antennas incorporating dielectric rings according to some embodiments of the present disclosure.

FIGS. 9A-B are diagrams showing modeled electric fields over and in antennas according to some embodiments of the present disclosure.

FIG. 10 is a plot showing amplitude ratio versus formation resistivity determined in accordance with one embodiment of the present disclosure.

FIG. 11 is a plot showing differential phase versus formation resistivity determined in accordance with one embodiment of the present disclosure.

FIG. 12 is a plot showing amplitude ratio versus formation resistivity determined in accordance with one embodiment of the present disclosure.

FIG. 13 is a plot showing differential phase versus formation resistivity determined in accordance with one embodiment of the present disclosure.

FIG. 14 is a flow chart showing a process in accordance with some embodiments of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. It may also include one or more interface units capable of transmitting one or more signals to a controller, actuator, or like device.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

Illustrative embodiments of the present disclosure are described in detail herein. In the interest of clarity, not all features of an actual implementation may be described in this specification. It will of course be appreciated that in the development of any such actual embodiment, numerous implementation-specific decisions are made to achieve the specific implementation goals, which will vary from one implementation to another. Moreover, it will be appreciated that such a development effort might be complex and time-consuming, but would, nevertheless, be a routine undertaking for those of ordinary skill in the art having the benefit of the present disclosure.

To facilitate a better understanding of the present disclosure, the following examples of certain embodiments are given. In no way should the following examples be read to limit, or define, the scope of the invention. Embodiments of the present disclosure may be applicable to horizontal, vertical, deviated, or otherwise nonlinear wellbores in any type of subterranean formation. Embodiments may be applicable to injection wells as well as production wells, including hydrocarbon wells. Embodiments may be implemented using a tool that is made suitable for testing, retrieval and sampling along sections of the formation. Embodiments may be implemented with tools that, for example, may be conveyed through a flow passage in tubular string or using a wireline, slickline, coiled tubing, downhole robot or the like. “Measurement-while-drilling” (“MWD”) is the term generally used for measuring conditions downhole concerning the movement and location of the drilling assembly while the drilling continues. “Logging-while-drilling” (“LWD”) is the term generally used for similar techniques that concentrate more on formation parameter measurement. Devices and methods in accordance with certain embodiments may be used in one or more of wireline (including wireline, slickline, and coiled tubing), downhole robot, MWD, and LWD operations.

The terms “couple” or “couples” as used herein are intended to mean either an indirect or a direct connection. Thus, if a first device couples to a second device, that connection may be through a direct connection or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections.

The present disclosure relates generally to subterranean drilling operations and, more particularly, the present disclosure relates to formation sensing systems, apparatus, and methods.

The present disclosure in some embodiments provides methods and systems for analyzing characteristics of a subterranean formation (e.g., resistivity and/or dielectric constant, which may also be referred to as permittivity). The methods and systems of some embodiments may include one or more logging tools. In some embodiments, a logging tool may include a tool body and one or more antennas, each of which may act as a transmitter and/or a receiver of an electromagnetic signal or signals. An antenna according to some embodiments may include a dielectric slab at least partially buried within a cladding and a feeding probe. In some embodiments, at least a portion of the tool body of the logging tool may act as the cladding of an antenna included in the logging tool.

The logging tools of some embodiments each may include an array of two, three, or more antennas. In some embodiments, one or more antennas may individually or collectively act as a transceiver (i.e., devices capable of both transmitting and receiving) of an electromagnetic signal or signals. Such electromagnetic signal(s) may be used to determine the resistivity (and/or dielectric constant) of the formation. For example, the logging tools of some embodiments may measure the attenuation and phase shift of a received signal relative to the attenuation and phase shift of a transmitted signal. These measurements may be made at each of one or more receiving antennas in response to signals transmitted by one or more transmitting antennas, with each of the one or more transmitters of some embodiments transmitting signals in turn (e.g., successively). Furthermore, where each of multiple receivers receives a signal, differential phase and attenuation measurements may be calculated (i.e., the phase and attenuation of one signal frequency measured at a first receiver relative to the phase and attenuation of that signal frequency at a second receiver may be calculated or otherwise determined). Resistivity and/or dielectric constant of the formation may be determined from signal attenuation and phase shift experienced. For example, the relationship between attenuation and phase shift on the one hand, and resistivity and dielectric constant on the other hand, may be modeled and mapped, e.g., in computer readable media as part of or communicatively coupled to an information handling system. From there, mapping from the measured quantities (attenuation and phase shift) to the properties of resistivity and dielectric constant may be performed (e.g., by means of look-up tables, inversion techniques, or other suitable conversion methods).

A dielectric slab according to some embodiments may include any material suitable for use in constructing a dielectric slab antenna (e.g., any material useful in acting as a waveguide antenna). The dielectric slab of some embodiments may be at least partially buried by a cladding, except for a portion of the slab at an exposed end of the slab that extends to a radiation slot in a surface of the cladding. As used herein, a dielectric slab included in a logging tool may be “at least partially buried” by the cladding of the tool when a surface of the dielectric slab that faces outward from the center of the tool is at least partially covered by the cladding of the tool. A portion or end of the slab that is so covered by the cladding may be referred to as a “buried portion” or “buried end,” respectively.

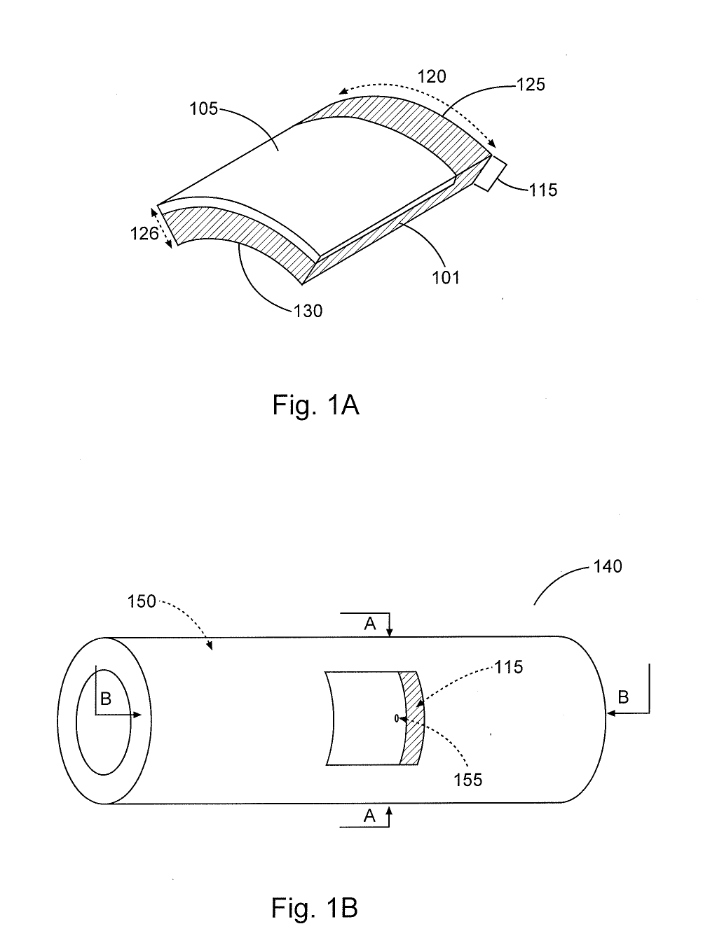

The dielectric slab may be of flat planar geometry (e.g., without curvature along a surface of the slab) or it may be of curved geometry (e.g., it may be substantially in the shape of a wedge of a cylinder, as the dielectric slab 101 shown in FIG. 1A). It may be of substantially uniform width W, and have thickness T. Width W of a dielectric slab as used herein is the measurement along the exposed end of the dielectric slab, which is parallel to the opposite, buried end of the slab, as shown by measurement 120 in FIG. 1A. As noted, in some embodiments the slab is of substantially uniform width, such that width W may also be taken as the measurement along the buried end of the slab. Thickness T is measured in a direction such that it varies across the dielectric slab; that is, the exposed end of the slab has greater thickness than the remainder of the slab. Put another way, thickness T is measured in a direction substantially perpendicular to the plane of the surface of the cladding—or, where slab geometry is curved as in a wedge of a cylinder, thickness T is in the radial direction toward the center of the cylinder. For example, thickness T shown at measurement 126 in FIG. 1A is measured in a radial direction. As used herein, measurements of thickness T refer to the measurement of thickness of the dielectric slab in the non-exposed portion of the slab.

The width W of the dielectric slab may be equal to about ½ the wavelength of an electromagnetic signal transmitted and/or received according to the systems and methods of some embodiments. In some embodiments, width W may be from about 2 cm to about 25 cm; in other embodiments, it may be from about 2 cm to about 5 cm; from about 2 cm to about 10 cm, or from about 2 cm to about 20 cm. In other embodiments, width W may range from about 5 cm to about 10 cm; from about 5 cm to about 15 cm, or from about 5 cm to about 20 cm. In other embodiments, width may be as small as about 1 cm or about 1.5 cm, or as large as about 30 cm or about 35 cm.

In various embodiments, as noted, wavelength may be proportional to the width W of the slab (e.g., it may be approximately twice the width W), so the thickness T of the slab may therefore be minimized without adversely affecting the wavelength of electromagnetic signals that the dielectric slab may be capable of transmitting and/or receiving. In particular, in some embodiments, the slab thickness T may be less than 20 cm. In some embodiments, thickness T may be less than 15 cm, and in other embodiments, less than 10 cm. In some embodiments, T may be as little as 0.5 cm, or in other embodiments as little as 1 cm. For example, thickness T some embodiments may range from about 0.5 cm to 15 cm; or it may range from about 1 cm to about 10 cm; or from 1 cm to about any of 2, 3, 4, 5, 6, 7, 8, or 9 cm. It may alternatively be as small as 2, 3, or 4 cm. This low-profile feature of some embodiments may make logging tools including such antennas particularly suitable for integration into a portion of a drill string (such as, e.g., a drill collar or mandrel), or into a wireline tool, in a manner such that the thickness of the slab is measured inward from an outer surface of the collar, mandrel, or wireline tool (e.g., a surface proximal to a wellbore when such devices are in a downhole such as a well).

Furthermore, the dielectric slabs of such embodiments may be capable of transmitting and/or receiving electromagnetic signals with much higher wavelengths (and concomitantly much lower frequencies) than conventional downhole antennas. For example, the dielectric slabs of some embodiments may be capable of transmitting and/or receiving electromagnetic signals with frequencies as low as 500 MHz or less. In various embodiments, transmitted and/or received electromagnetic signal frequency may be about equal to or less than any one or more of: 200 MHz, 150 MHz, 100 MHz, 50 MHz, 1 MHz, 500 kHz, 100 kHz, 50 kHz, or 10 kHz. Furthermore, in some embodiments, any of the aforementioned frequencies may be either an upper or lower limit of frequencies of electromagnetic signals capable of being transmitted and/or received by the dielectric slab. That is, for example, some embodiments may employ electromagnetic signals having frequency ranging from about 10 kHz to 50 kHz, to 100 kHz, or to 500 kHz, or to 100 MHz, or to 150 MHz etc., while other embodiments may employ electromagnetic signals having frequency ranging from about 500 kHz to about 150 MHz. In certain embodiments, lower frequency (i.e., higher wavelength) signals may enable sensing of significantly deeper portions of a subterranean formation than conventional antennas. And, as previously discussed, increasing the permitted received and/or transmitted wavelengths (i.e., reducing permitted received and/or transmitted frequencies) does not require a concomitant increase in thickness of the dielectric slabs of some embodiments.

The cladding of some embodiments may surround or otherwise encase at least a portion of the dielectric slab such that the dielectric slab is at least partially buried within the cladding. The cladding may include a radiation slot (e.g., an opening) at an outward-facing surface of the cladding, that is, a surface of the cladding facing a subterranean formation when the logging tool is in a downhole environment such as a well. In some embodiments, the dielectric slab may be extended to the outward-facing surface of the cladding at the radiation slot so as to form an aperture from which an electromagnetic signal may be transmitted (and/or into which an electromagnetic signal may be received). The radiation slot may in some embodiments be on a surface of the cladding that faces a direction in which an electromagnetic signal is to be transmitted (or, likewise, from which such a signal is to be received). In some embodiments, the portion of the dielectric slab at the aperture is the only portion of the dielectric slab physically exposed to the environment surrounding the logging tool.

In some embodiments, either or both of the dielectric slab and cladding may have sufficient corrosion resistance and/or mechanical strength to be deployed in a downhole environment (e.g., in a well). Such corrosion resistance and mechanical strength may be due at least in part to the material of construction of either or both of the dielectric slab and the cladding. Thus, for example, the dielectric slab may be composed in whole or in part of any one or more suitable materials such as, e.g., low index dielectric ceramic. Likewise, the cladding may be composed in whole or in part of any one or more suitable materials such as, e.g., steel or metal alloys. In some embodiments, the cladding may be composed in whole or in part of the same material as (or a material substantially similar to) the material of construction as a drill collar, mandrel, wireline tool, or other device incorporating the logging tool. The feeding probe of some embodiments may include any means capable of conveying an electromagnetic wave to the dielectric slab. For example, it may be a center conductor of a feeding coaxial cable communicatively coupled to the dielectric slab. In other embodiments, it may be any transmission line or portion of a transmission line (e.g., parallel line or ladder line, dielectric waveguide, stripline, optical fiber, and/or waveguide) communicatively coupled to the dielectric slab. The feeding probe may in certain embodiments physically extend into the dielectric slab. Furthermore, in some embodiments, the distance between the feeding probe and the buried end of the dielectric slab (that is, the end opposite the exposed end) should be equal to about 1/4 the wavelength of an electromagnetic signal transmitted and/or received by the dielectric slab. In some embodiments, the feeding probe may be or may include any of the above means or any other means capable of conveying an electromagnetic wave in a frequency range that the dielectric slabs of various embodiments are capable of transmitting and/or receiving, as discussed previously.

Furthermore, the feeding probe of some embodiments may be capable of conveying electromagnetic waves of varying frequencies to or from the dielectric slab. That is, the feeding probe may convey a first electromagnetic wave of a first frequency to or from the dielectric slab, and may at a later point in time convey a second electromagnetic wave of a second, different, frequency to or from the dielectric slab. Frequency of electromagnetic waves conveyed to the dielectric slab may be controlled or otherwise affected by conventional means such as, e.g., a power source communicatively coupled to the feeding probe. A power source may be located near the feeding probe (e.g., within the logging tool, or within a drilling collar, mandrel, or wireline tool incorporating the logging tool), or it may be located remotely from the feeding probe (e.g., at the surface of a well). The power source and/or feeding probe may in some embodiments be communicatively coupled to an information handling system for, e.g., control of electromagnetic waves conveyed to and through the feeding probe, and/or recording and/or monitoring of electromagnetic waves conveyed by the feeding probe from the dielectric slab (e.g., as a result of an electromagnetic signal received by the dielectric slab).

FIGS. 1A and 1B illustrate an example arrangement of a dielectric slab and cladding according to some embodiments. FIG. 1A shows an example of embodiments wherein a dielectric slab 101 is at least partially buried in the cladding 105, except for a portion of the slab extended to the surface of the portion of cladding 105 shown in FIG. 1A at the radiation slot so as to form an aperture 115. In some such example embodiments, as shown in FIG. 1A, width 120 of the dielectric slab equal to about ½ the wavelength of an electromagnetic signal to be transmitted and/or received by the slab is measured along the exposed end 125 or the buried end 130 opposite the exposed end (which as previously noted is approximately equal in width to the extended end 125 in some embodiments). FIG. 1A additionally shows thickness 126 of the dielectric slab as measured at the buried end 130. FIG. 1B illustrates a logging tool 140 incorporating the slab 101 into the logging tool body 150 (which could, in some embodiments, be at least a portion of a drilling collar, mandrel, wireline tool, or other suitable device). As can be seen in FIG. 1B, at least a portion of the tool body 150 may serve as the cladding 105 of FIG. 1A. FIG. 1B likewise illustrates the extended portion of the dielectric slab occupying the radiation slot of the cladding to form an aperture 115, and furthermore illustrates an embodiment wherein only the extended portion of the dielectric slab is exposed to an environment surrounding the logging tool 140. FIG. 1B further shows the point 155 at which a feeding probe may be coupled to the dielectric slab 101, forming an antenna within the tool body 150.

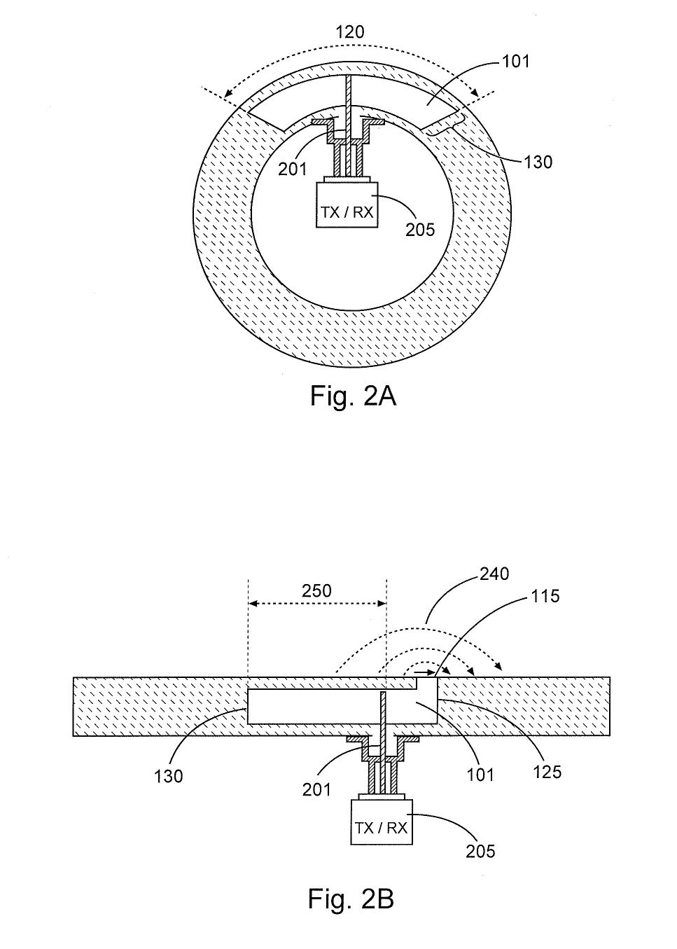

FIG. 2A illustrates a cross-sectional view of the example antenna of FIG. 1B along line A-A of FIG. 1B. It shows the buried end 130 of the dielectric slab 101, along which width 120 may be measured. It further shows a feeding probe 201 communicatively coupled with the dielectric slab 101 (in this case, by extension into the dielectric slab 101), extending from electromagnetic wave transmitting and/or receiving means 205, e.g. a transceiver (which may, in some embodiments, include any one or more of an information handling system and a power source, as previously discussed). Furthermore, although shown in proximity to the feeding probe in FIG. 2A, the electromagnetic transmitting and/or receiving means 205 may be located remotely from the feeding probe 201, as previously discussed.

FIG. 2B illustrates a cross-sectional view of the example antenna of FIG. 1B along line B-B of FIG. 1B. It shows the portion of the dielectric slab 101 extending into the radiation slot within the cladding 105 to form the aperture 115. FIG. 2B provides an illustration of the distance 250 between the feeding probe 201 and buried end 130 of some embodiments, which may as previously discussed be approximately equal to ¼ wavelength of electromagnetic signals to be received and/or transmitted by the dielectric slab. FIG. 2B further illustrates an example radiation field pattern 240 that may exist over the aperture 115.

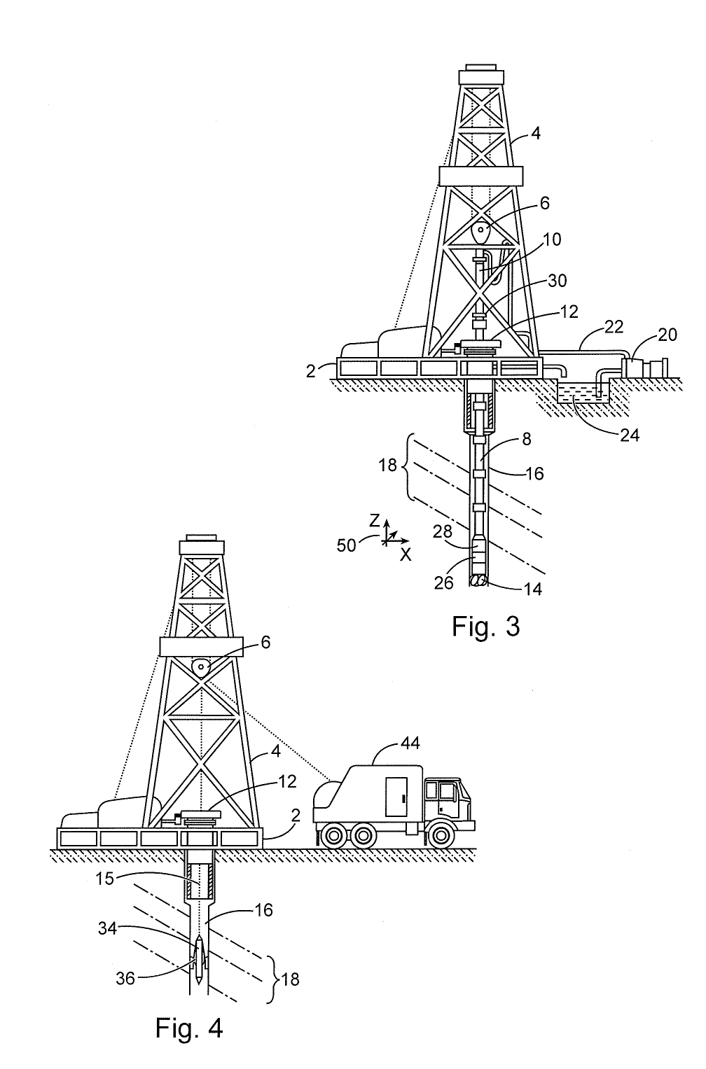

As noted, the example antennas discussed in FIGS. 1B, 2A, and 2B are implemented in a logging tool (such as logging tool 140), which in turn may be integrated into a drilling collar, mandrel, wireline tool, or other suitable device. In some embodiments, such logging tools may be included and/or used in a logging-while-drilling (LWD) environment. FIG. 3 illustrates oil well drilling equipment used in an illustrative LWD environment. A drilling platform 2 supports a derrick 4 having a traveling block 6 for raising and lowering a drill string 8. A kelly 10 supports the drill string 8 as it is lowered through a rotary table 12. A drill bit 14 is driven by a downhole motor and/or rotation of the drill string 8. As bit 14 rotates, it creates a borehole 16 that passes through one or more formations 18. A pump 20 may circulate drilling fluid through a feed pipe 22 to kelly 10, downhole through the interior of drill string 8, through orifices in drill bit 14, back to the surface via the annulus around drill string 8, and into a retention pit 24. The drilling fluid transports cuttings from the borehole 16 into the pit 24 and aids in maintaining integrity or the borehole 16.

A logging tool 26 may be integrated into the bottom-hole assembly near the bit 14 (e.g., within a drilling collar, i.e., a thick-walled tubular that provides weight and rigidity to aid in the drilling process, or a mandrel). In some embodiments, the logging tool 26 may be integrated at any point along the drill string 8. The logging tool 26 may include receivers and/or transmitters (e.g., antennas capable of receiving and/or transmitting one or more electromagnetic signals). In some embodiments, the logging tool 26 may include a transceiver array that functions as both a transmitter and a receiver. As the bit extends the borehole 16 through the formations 18, the logging tool 26 may collect measurements relating to various formation properties as well as the tool orientation and position and various other drilling conditions. The orientation measurements may be performed using an azimuthal orientation indicator, which may include magnetometers, inclinometers, and/or accelerometers, though other sensor types such as gyroscopes may be used in some embodiments. In embodiments including an azimuthal orientation indicator, resistivity and/or dielectric constant measurements may be associated with a particular azimuthal orientation (e.g., by azimuthal binning). A telemetry sub 28 may be included to transfer tool measurements to a surface receiver 30 and/or to receive commands from the surface receiver 30.

At various times during the drilling process, the drill string 8 may be removed from the borehole 16 as shown in FIG. 4. Once the drill string has been removed, logging operations can be conducted using a wireline tool 34, i.e., an instrument that is suspended into the borehole 16 by a cable 15 having conductors for transporting power to the tool and telemetry from the tool body to the surface. The wireline tool 34 may include one or more logging tools 36 according to the present disclosure where the tool body of the wireline tool 34 may be used as the cladding (such as the cladding 105 illustrated as FIGS. 1A and 1B). The logging tool 36 may be communicatively coupled to the cable 15. A logging facility 44 (shown in FIG. 4 as a truck, although it may be any other structure) may collect measurements from the logging tool 36, and may include computing facilities (including, e.g., an information handling system) for controlling, processing, and/or storing the measurements gathered by the logging tool 36. The computing facilities may be communicatively coupled to the logging tool 36 by way of the cable 15.

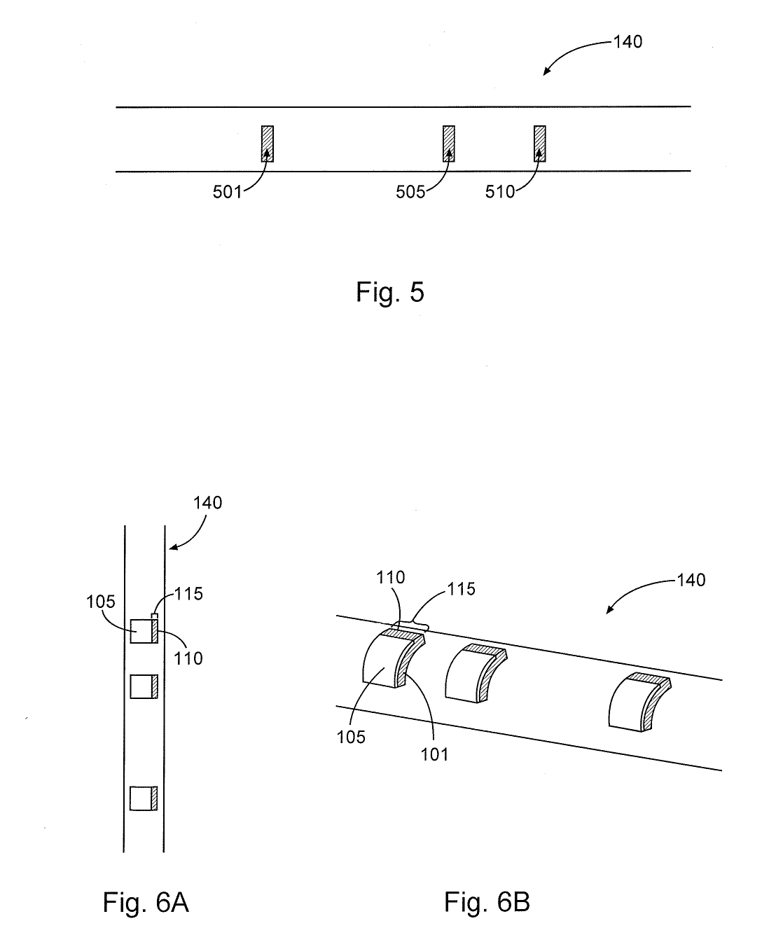

The logging tools of some embodiments may each include multiple antennas. FIG. 5, for example, illustrates an example embodiment including three antennas: a transmitter 501 and two receivers 505 and 510 within a mandrel 520. The antennas of various embodiments may be used to measure resistivity and/or conductivity of at least a portion of a subterranean formation. Such measurement may include using one or more antennas to transmit one or more electromagnetic signals into at least a portion of the subterranean formation, and using one or more receiving antennas (which in some embodiments may be different than the transmitting antennas) to receive return electromagnetic signals from the subterranean formation. A return electromagnetic signal may be a modulated version (for example, but not necessarily, a reflection) of the transmitted electromagnetic signal from the formation, and it may be different (e.g., in wavelength and, concomitantly, frequency, or in phase and/or attenuation) than the transmitted electromagnetic signals due at least in part to the formation characteristics (such as resistivity and/or dielectric constant). As will be appreciated by one of ordinary skill in the art, transmission and/or receipt of one or more electromagnetic signals may include transmission and/or receipt of one or more electric and/or magnetic fields. Formation resistivity and/or conductivity may be analyzed by the usual means, based at least in part upon the transmitted and received electromagnetic signals.

In some embodiments, an antenna's aperture may be oriented substantially perpendicularly with respect to the longitudinal or z-direction (as shown by axis 50 in FIG. 3) of a logging tool, as shown in, e.g., FIGS. 1B and 5. Dielectric slabs according to such embodiments may be polarized in the longitudinal or z-direction (e.g., by reference to FIG. 1A, the slab may be polarized in a direction from the buried end 130 to the extended end 125). In other embodiments, the aperture may be oriented substantially parallel to the longitudinal or z-direction, as in FIGS. 6A and 6B, and the dielectric slab polarized in a direction substantially perpendicular to the longitudinal or z-direction.

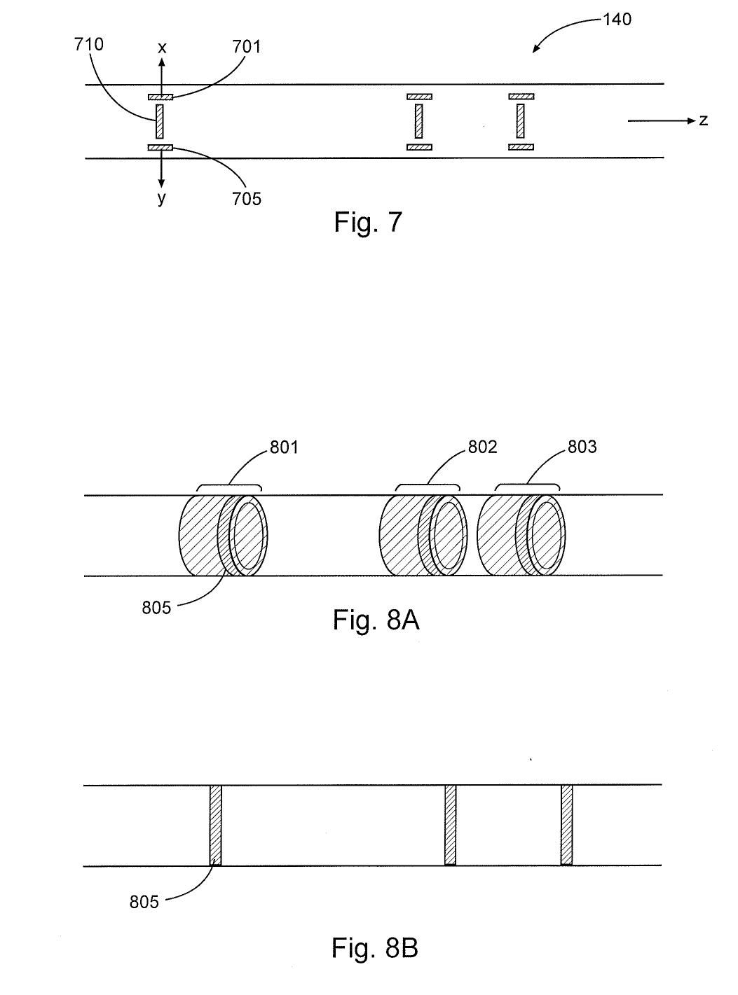

In yet other embodiments, multiple antennas' respective apertures may not all be oriented in the same direction. For example, FIG. 7 shows an example embodiment including three sets of tri-axial antennas. Each set shown in the embodiment of FIG. 7 includes three antennas: two (e.g., antennas 701 and 705) with apertures oriented substantially parallel to the z-direction; and one (e.g., antenna 710) with aperture oriented substantially perpendicular to the z-direction. Antennas 701 and 705 are polarized substantially perpendicularly to the z-direction, and furthermore in directions opposite to each other (e.g., substantially parallel to the x and y directions, respectively, of FIG. 7). Antenna 710 is polarized substantially in the z-direction. Other combinations of orientations may be employed (e.g., two antennas each with apertures oriented in the z-direction and one with aperture oriented perpendicularly to the z-direction), as will be recognized by one of ordinary skill in the art with the benefit of this disclosure.

In other embodiments, the antenna's radiation aperture may be increased by forming a ring around the logging tool 140, as shown in FIG. 8A. The dielectric pad of such embodiments becomes a dielectric ring (such as the dielectric ring shown in antenna 801). Each such ring may be communicatively coupled to any feeding probe suitable for use in dielectric slab antennas of other embodiments. The aperture of each such antenna (e.g., aperture 805) may therefore extend around the circumference of the logging tool, as shown in FIG. 8B.

In some embodiments, any of the above-described antenna layouts and/or orientations may be used to detect filled fractures whose properties were altered with nano-materials, so as to enhance permittivity and resistivity.

In addition, in some embodiments, any of the above-described antenna layouts and/or orientations may be used to monitor the dielectric constant and resistivity of the formation and to detect water and/or hydrocarbon movement. Such monitoring may be in real-time (e.g., by way of communicative coupling to monitoring means such as an information handling system).

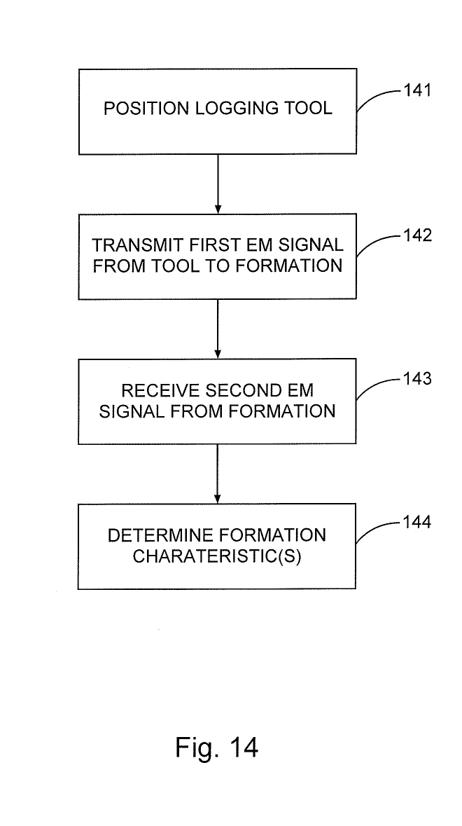

Example methods of analyzing a subterranean formation using a logging tool according to some embodiments may be illustrated by reference to FIG. 14. Such methods may include, for instance, positioning a logging tool downhole (141); transmitting a first electromagnetic signal from the logging tool to the formation (142); receiving (e.g., at the logging tool) a second electromagnetic signal from the formation (143); and determining one or more characteristics of the formation (144), which determination may be based at least in part upon the second electromagnetic signal. The logging tool used in some embodiments may include an antenna consistent with the above description. For instance, the logging tool may include a tool body having radiation slot disposed at an outer surface of the tool body, and it may further include an antenna comprising: (i) a dielectric slab at least partially buried by the tool body, having an exposed end of the dielectric slab extending to the outer surface of the tool body and at least partially filling the radiation slot; and (ii) a feeding probe communicatively coupled to the dielectric slab. Furthermore, in some embodiments, the second electromagnetic signal, received at the logging tool from the formation, may be a modulated version of the first electromagnetic signal transmitted from the logging tool to the formation. Methods and apparatus according to some embodiments may additionally be illustrated by reference to the examples below.

### EXAMPLES

### Example 1

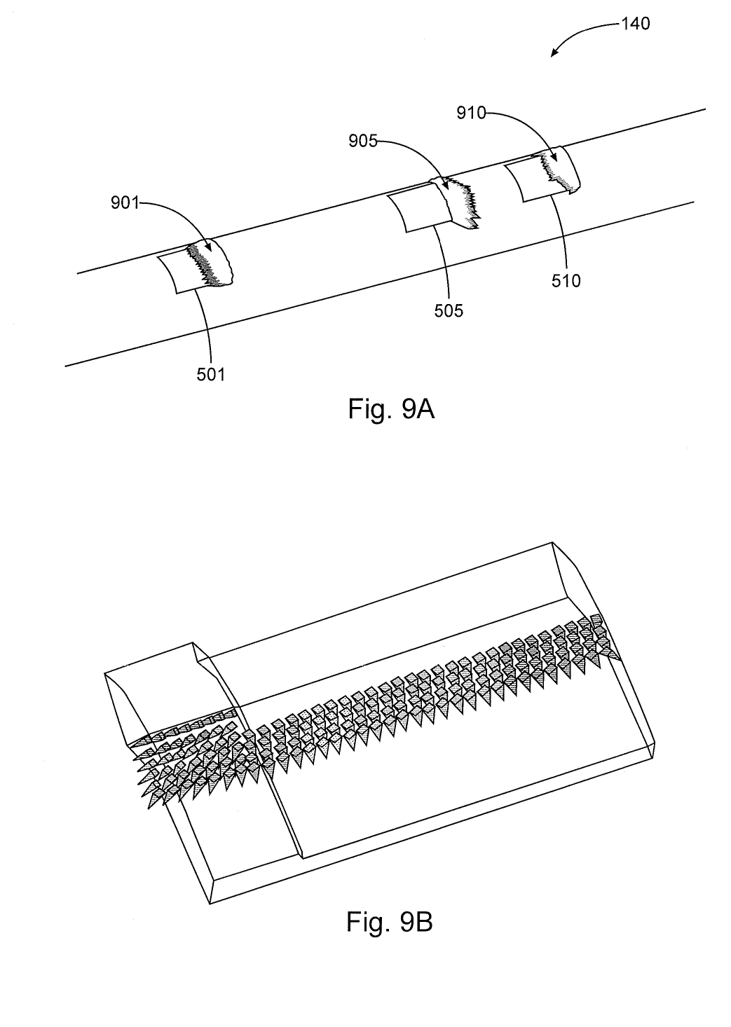

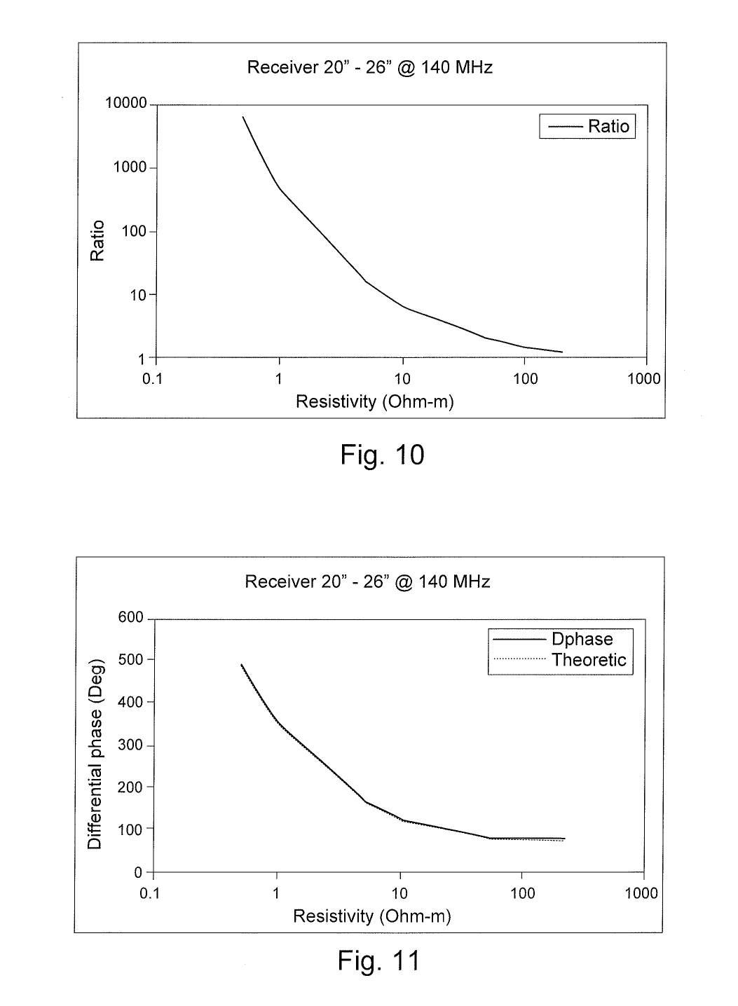

A logging tool including three substantially identical antennas working at 140 MHz was integrated into a mandrel, with the antennas in an orientation and layout similar to that shown for the logging tool in FIG. 5, including one transmitting antenna (corresponding to antenna 501) and two receiving antennas (corresponding to antennas 505 and 510, respectively). The transmitter was positioned approximately 20 inches from the first receiver (corresponding to antenna 505) and 26 inches from the second receiver (corresponding to antenna 510), respectively. The electric fields over each antenna's aperture 901, 905, and 910 (respectively corresponding to transmitting antenna 501 and receiving antennas 505 and 510), were modeled as shown in FIG. 9A. The modeled fields were tangential to the collar surface and polarized in the longitudinal or z-direction. The electric field within each antenna is shown in FIG. 9B, illustrating the polarity of the field within each antenna. The antenna system was placed into different formations, the resistivity of which ranged from 0.5 Ohm-m to 200 Ohm-m. The modeled amplitude ratio and differential phase between the two receiving antennas were plotted, as shown in FIGS. 10 and 11, respectively. In addition, FIG. 11 includes the theoretically estimated differential phases between the two receiving antennas for comparison.

### Example 2

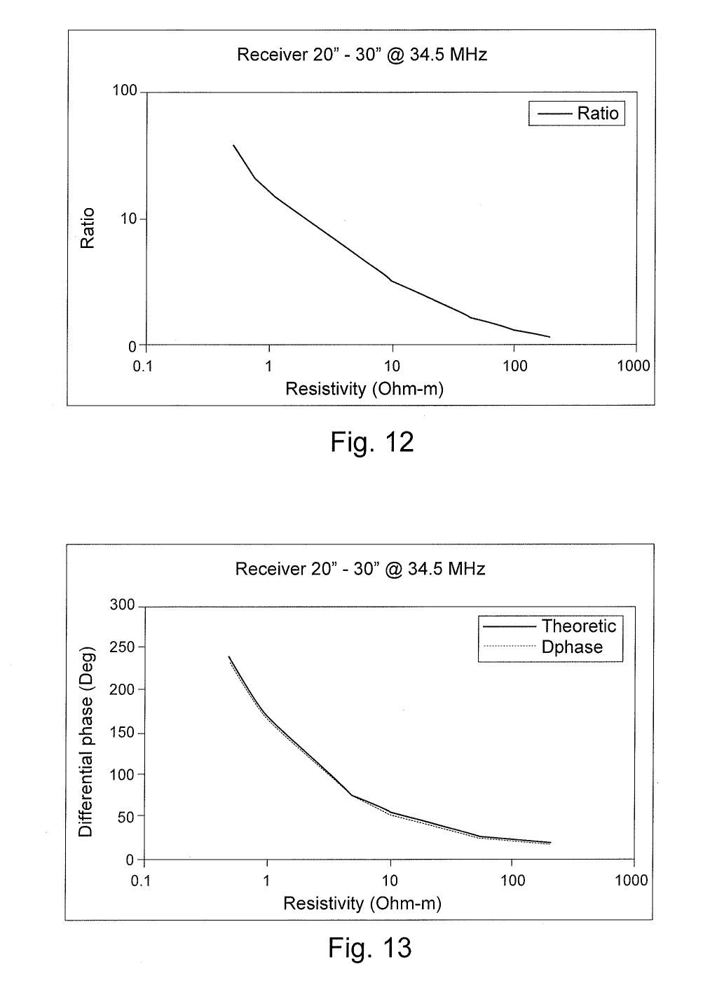

A logging tool including three substantially identical antennas working at 34.5 MHz was integrated into a mandrel, with the antennas in an orientation and layout similar to that shown for the logging tool in FIGS. 8A and 8B, including one transmitting antenna (corresponding to antenna 801) and two receiving antennas (corresponding to antennas 802 and 803, respectively). The transmitter was positioned approximately 20 inches from the first receiver (corresponding to antenna 802) and 30 inches from the second receiver (corresponding to antenna 803), respectively. The antenna system was placed into the same formations (resistivity ranging from 0.5 Ohm-m to 200 Ohm-m). The modeled amplitude ratio and differential phase between the two receiving antennas were plotted, as shown in FIGS. 12 and 13, respectively. In addition, FIG. 13 includes the theoretically estimated differential phases between the two receiving antennas for comparison.

As would be appreciated by those of ordinary skill in the art, with the benefit of this disclosure, in one exemplary embodiment, the methods, systems, and apparatus disclosed herein may be implemented using an information handling system. In one embodiment, each of the one or more antennas of a logging tool may be communicatively coupled to an information handling system through a wired or wireless network. Operation of such systems are well known to those of ordinary skill in the art and will therefore not be discussed in detail herein. The information handling system may control generation, transmission, and/or receipt of electromagnetic signals by each antenna or antenna array and/or process the electromagnetic signals detected to analyze a subterranean formation. Specifically, software including instructions in accordance with the methods disclosed herein may be stored in computer-readable media of an information handling system. The information handling system may then use those instructions to carry out the methods disclosed herein. In one exemplary embodiment, the information handling system may store the values of the measured signal in each of multiple iterations as it carries out the methods disclosed herein. In one embodiment, the information handling system may include a user interface that may provide information relating to formation properties to a user in real time.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. A logging tool comprising:
a tool body having a radiation slot disposed at an outer surface of the tool body; and
an antenna comprising
a dielectric slab at least partially buried by the tool body, except for an exposed end of the dielectric slab extending through the radiation slot to the outer surface of the tool body; and
a feeding probe communicatively coupled to the dielectric slab.

2. The logging tool of claim 1 wherein the antenna is capable of transmitting an electromagnetic signal with frequency in a range of from about 10 kHz to about 100 MHz.

3. The logging tool of claim 1 wherein the antenna is capable of transmitting an electromagnetic signal with frequency in a range of from about 10 kHz to about 1 MHz.

4. The logging tool of claim 1 further comprising:
a second radiation slot and a third radiation slot disposed at the outer surface of the tool body;
a second antenna, wherein the second antenna comprises (i) a second dielectric slab mostly at least partially buried by the tool body, except for an exposed end of the second dielectric slab extending through the second radiation slot to the outer surface of the tool body, and (ii) a second feeding probe communicatively coupled to the second dielectric slab; and
a third antenna, wherein the third antenna comprises (i) a third dielectric slab at least partially buried by the tool body, except for an exposed end of the third dielectric slab extending through the third radiation slot to the outer surface of the tool body and filling a third radiation slot at the outer surface of the tool body, and (ii) a second feeding probe communicatively coupled to the second dielectric slab.

5. The logging tool of claim 4 wherein the antenna, the second antenna, and the third antenna are substantially identical.

6. The logging tool of claim 5 wherein the exposed end of the second dielectric slab and the exposed end of the third dielectric slab are oriented such that they are substantially parallel to each other.

7. The logging tool of claim 6 wherein the antenna is disposed to transmit a first electromagnetic signal into a subterranean formation, and wherein each of the second and third dielectric slab is disposed to receive a second electromagnetic signal from the formation, wherein the second electromagnetic signal is a modulated version of the first electromagnetic signal from the formation.

8. The logging tool of claim 5 wherein the exposed end of the antenna is oriented such that it is substantially perpendicular to each of the exposed ends of the second and the third antennas, and wherein the exposed end of the second antenna and the exposed end of the third antenna are oriented such that they are substantially parallel to each other.

9. The logging tool of claim 8 wherein each of the antenna, the second antenna, and the third antenna is capable of transmitting one or more electromagnetic signals into a subterranean formation.

10. An antenna comprising:
a cladding comprising a radiation slot at an outer surface of the cladding; and
an antenna comprising
a dielectric slab at least partially buried by the cladding, except for an exposed end of the dielectric slab extending through the radiation slot to the outer surface of the cladding; and
a feeding probe communicatively coupled to the dielectric slab.

11. The antenna of claim 10 wherein the thickness of the dielectric slab is less than 10 cm, and wherein the antenna is capable of transmitting an electromagnetic signal having frequency of about 10 kHz to about 100 MHz.

12. The antenna of claim 11 wherein the width of the antenna is equal to approximately one-half the wavelength of the electromagnetic signal that the antenna is capable of generating.

13. The antenna of claim 10 wherein the dielectric slab comprises a low index dielectric ceramic and wherein the cladding comprises a metal alloy.

14. A method of analyzing a subterranean formation comprising:
positioning a logging tool downhole, wherein the logging tool comprises:
a tool body having a radiation slot disposed at an outer surface of the tool body, and
an antenna comprising (i) a dielectric slab at least partially buried by the tool body, having an exposed end of the dielectric slab extending through the radiation slot to the outer surface of the tool body, and (ii) a feeding probe communicatively coupled to the dielectric slab;
transmitting a first electromagnetic signal from the logging tool to the formation;
receiving, at the logging tool, a second electromagnetic signal from the formation, wherein the second electromagnetic signal is a modulated version of the first electromagnetic signal from the formation; and
determining one or more characteristics of the formation based at least in part upon the second electromagnetic signal.

15. The method of claim 14 wherein the first electromagnetic signal is transmitted, and the second electromagnetic signal is received, while a drill string including the logging tool is in a wellbore penetrating the subterranean formation.

16. The method of claim 14 wherein positioning the logging tool comprises lowering the tool into a well using a wireline prior to transmitting the first electromagnetic signal.

17. The method of any one of claims 14 through 16 wherein the width of the dielectric slab is equal to approximately one-half the wavelength of the first electromagnetic signal.

18. The method of claim 17 wherein the feeding probe extends into the dielectric slab at a point that is a distance away from a buried end of the dielectric slab, which distance is approximately equal to one-fourth the wavelength of the first electromagnetic signal.

19. The method of any one of claims 14 through 16 wherein the frequency of the first electromagnetic signal is between about 10 kHz and about 100 MHz.

20. The method of claim 19 wherein the thickness of the first dielectric slab is less than 10 cm.
